(19) United States
(12) Patent Application Publication
(10) Pub. No.: US 2014/0247488 A1
(43) Pub. Date: Sep. 4, 2014

(54) LENS, LENS UNIT, AND LENS MANUFACTURING METHOD

(71) Applicant: Olympus Corporation, Tokyo (JP)

(72) Inventor: NORIMITSU NAGAYAMA, Tokyo (JP)

(73) Assignee: Olympus Corporation, Tokyo (JP)

(21) Appl. No.: 14/277,862

(22) Filed: May 15, 2014

Related U.S. Application Data
(63) Continuation of application No. PCT/JP2013/057167, filed on Mar. 14, 2013.

(30) Foreign Application Priority Data
Mar. 29, 2012 (JP) 2012-075926

(51) Int. Cl. G02B 7/02; B29D 11/00; G02B 3/00

(52) U.S. Cl. CPC G02B 7/022; G02B 3/00; B29D 11/00009
USPC 359/503; 359/642; 359/819; 264/2.5

(57) ABSTRACT

A first lens includes, on end surfaces of both ends in a direction along an optical axis, a first lens surface, a second lens surface, lens outer edges formed on outer peripheral sides of the first and second lens surfaces, and a lens side surface that is adjacent to the lens outer edges and serves as an outermost surface in a direction orthogonal to the optical axis. The first lens is provided so as to be mountable on a lens holding frame. In the first lens, a first abutment surface provided within one plane orthogonal to the optical axis is provided on at least one of the lens outer edges. A second projection is formed on at least one of the lens outer edges so as to protrude in the direction along the optical axis from a position closer to an inner peripheral side than the lens side surface, and the second projection has a reference cylindrical surface provided in a fixed positional relationship with the optical axis in the direction orthogonal to the optical axis.

This application is a Continuation of International Application No. PCT/JP2013/057167 filed on Mar. 14, 2013, which claims benefit of Japanese Patent Application No. 2012-075926 filed on Mar. 29, 2012. The entire contents of each application noted above are hereby incorporated by reference.

### TECHNICAL FIELD

1. Technical Field

The present invention relates to a lens, a lens unit, and a lens manufacturing method.

2. Background Art

In the related art, when a lens is used in an optical instrument, a lens unit is configured such that the lens is held by a lens holding frame having an attachment reference, and this lens unit is attached to the inside of the optical instrument.

In such a lens unit, a holding hole that allows the lens to be inserted thereinto is provided in the lens holding frame, and a lens side surface that is an outer peripheral surface of the lens is fitted to an inner peripheral surface of the holding hole to determine the position of the lens in a radial position orthogonal to the optical axis. Thereafter, the position of the lens with respect to the lens holding frame is fixed, for example, by bonding or the like.

In this case, in order to perform assembling without adjustment, the difference between the internal diameter of the holding hole and the external diameter of the lens is required to fall within the allowable range of eccentricity.

For example, Japanese Unexamined Patent Application, First Publication No. 2010-191464 discloses a plastic lens positioning method in which conical abutting surfaces are provided on inner sides than lens side surfaces in plastic lenses and the lenses are allowed to abut each other with the conical abutting surfaces, thereby performing the positioning between the lenses in an optical axis direction and in a direction orthogonal to the optical axis, and one lens outer peripheral surface in an assembly of the plurality lenses is fitted to a lens frame (lens holding frame) to perform the positioning of the lens assembly and the lens frame in the direction orthogonal to the optical axis.

### SUMMARY OF THE INVENTION

A lens according to a first aspect of the present invention includes a lens side surface which has a lens surface portion and a plurality of lens outer edges formed on an outer peripheral side of the lens surface portion on end surfaces of both ends in a direction along an optical axis. The lens side surface is adjacent to the lens outer edge and serves as an outermost surface in a direction orthogonal to the optical axis. The lens is mountable on a lens holding frame that covers the lens side surface from the outer peripheral side. An optical-axis-direction positioning portion is provided within one plane orthogonal to the optical axis and on at least one of the lens outer edges formed at the end surfaces of both the ends, respectively. A positioning projection is formed on at least one of the lens outer edges so as to protrude in the direction along the optical axis from a position closer to an inner peripheral side than the lens side surface, and the positioning projection has a radial positioning portion provided in a fixed positional relationship with the optical axis in the direction orthogonal to the optical axis.

In a second aspect of the present invention based on the first aspect, the positioning projection may include the optical-axis-direction positioning portion.

A lens unit of a third aspect of the present invention includes the lens according to the first aspect or the second aspect; and a lens holding frame which includes a lens fitting portion that fits the radial positioning portion of the lens, an optical-axis-direction reference surface that allows the optical-axis-direction positioning portion of the lens to abut thereagainst, and a lens accommodation hole that has a hole with a larger outer shape than the outer shape of the lens side surface of the lens. The lens may be positioned by being fitted to the lens fitting portion and abutted against the optical-axis-direction reference surface.

The lens unit according to a fourth aspect of the present invention based on the third aspect may include a plurality of the lenses. The optical-axis-direction reference surface abuts against the optical-axis-direction positioning portion of one of the plurality of lenses. The plurality of lenses may be fitted to a plurality of the lens fitting portions, respectively. The lenses that are arranged adjacent to each other may be positioned in the direction along the optical axis by abutting the optical-axis-direction positioning portions that are provided on the end surfaces that face each other.

A lens manufacturing method of a fifth aspect of the present invention includes a step of forming a molding tool assembly; and a step of molding a molding material using the molding tool assembly to form the outer shape of the lens according to the first aspect or the second aspect. The molding tool assembly includes a first molding tool member that transfers the shape of at least a portion of the lens outer edge and the shape of the lens surface portion in one of the end surfaces of both the ends; a second molding tool member that transfers the shape of at least a portion of the lens outer edge and the shape of the lens surface portion in the other of the end surfaces; and a third molding tool member that transfers the shape of at least the lens side surface. A radial positioning portion molding surface that transfers the shape of the radial positioning portion is formed so as to be provided on at least one of the first molding tool member and the second molding tool member.

In the lens manufacturing method according to the sixth aspect based on the fifth aspect, a molding surface for molding the lens surface portion of the end surface where the radial positioning portion may be further provided in the first molding tool member or the second molding tool member where the radial positioning portion molding surface is provided.

### BRIEF DESCRIPTION OF DRAWINGS

FIG. 1A is a cross-sectional view including optical axes schematically showing an example of a lens unit of a first embodiment of the present invention.

FIG. 1B is a right side view including the optical axes schematically showing the example of the lens unit of the first embodiment of the present invention.

FIG. 2A is a left side view schematically showing a first lens of the lens unit of the first embodiment of the present invention.

FIG. 2B is a cross-sectional view including an optical axis schematically showing the first lens of the lens unit of the first embodiment of the present invention.

FIG. 2C is a right side view schematically showing the first lens of the lens unit of the first embodiment of the present invention.

FIG. 3 is a cross-sectional view schematically showing the structure of a molding tool of manufacturing the lens of the first embodiment of the present invention.

FIG. 4A is a cross-sectional view including an optical axis schematically showing a second lens of the lens unit of the first embodiment of the present invention.

FIG. 4B is a right side view including the optical axis schematically showing the second lens of the lens unit of the first embodiment of the present invention.

FIG. 5A is a schematic right side view of a lens holding frame of the lens unit of the first embodiment of the present invention.

FIG. 5B is a cross-sectional view including a schematic central axis of the lens holding frame of the lens unit of the first embodiment of the present invention.

FIG. 6 is a schematic left side view of the lens holding frame of the lens unit of the first embodiment of the present invention.

FIG. 7A is a left side view schematically showing a lens of a modification example of the first embodiment of the present invention.

FIG. 7B is a cross-sectional view including an optical axis schematically showing the lens of the modification example of the first embodiment of the present invention.

FIG. 7C is a right side view schematically showing the lens of the modification example of the first embodiment of the present invention.

FIG. 8 is a cross-sectional view including optical axes schematically showing an example of a lens unit of a second embodiment of the present invention.

FIG. 9A is a cross-sectional view including an optical axis schematically showing a first lens of the lens unit of the second embodiment of the present invention.

FIG. 9B is a right side view including the optical axis schematically showing the first lens of the lens unit of the second embodiment of the present invention.

FIG. 10A is a left side view schematically showing a second lens of the lens unit of the second embodiment of the present invention.

FIG. 10B is a cross-sectional view including an optical axis schematically showing the second lens of the lens unit of the second embodiment of the present invention.

FIG. 11A is a cross-sectional view including a central axis of a lens holding frame of the lens unit of the second embodiment of the present invention.

FIG. 11B is a right side view including the central axis of the lens holding frame of the lens unit of the second embodiment of the present invention.

### PREFERRED EMBODIMENTS

Hereinafter, embodiments of the present invention will be described with reference to the accompanying drawings. In all the drawings, even in the case of different embodiments, the same reference numerals will be given to the same or equivalent members, and common description will be omitted.

### First Embodiment

A lens, a lens holding frame, and a lens unit of a first embodiment of the present invention will be described.

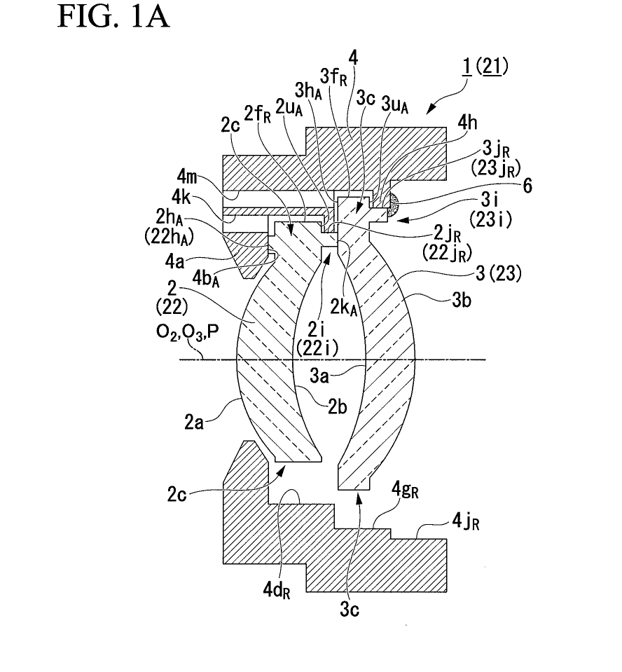

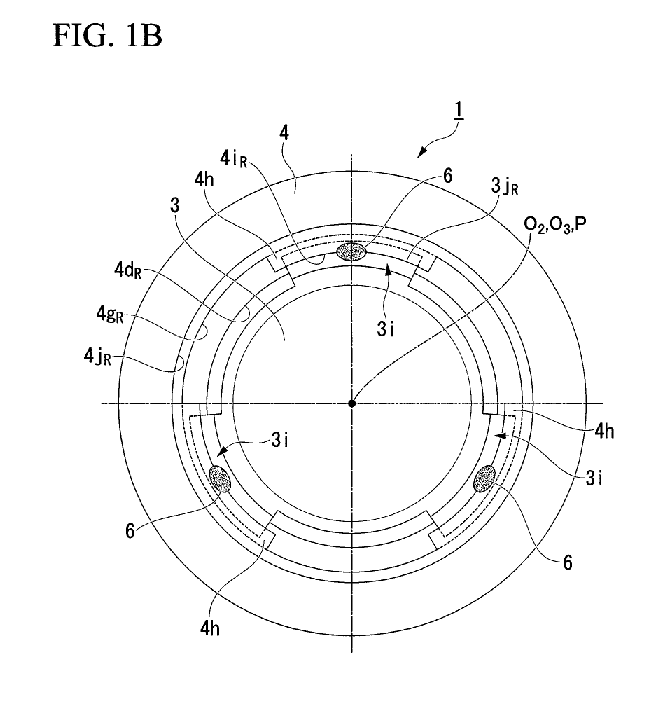

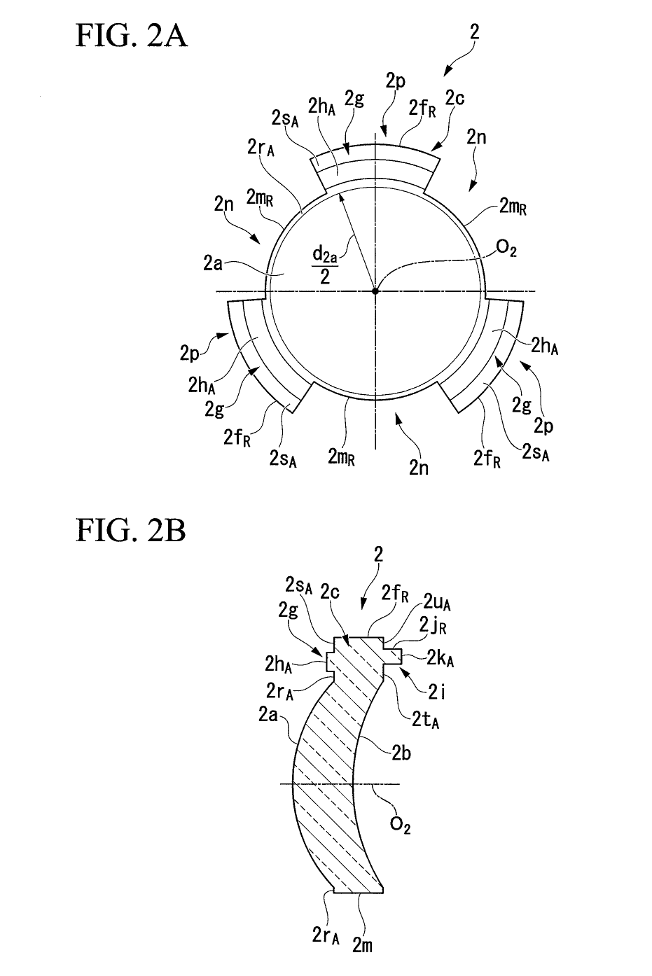

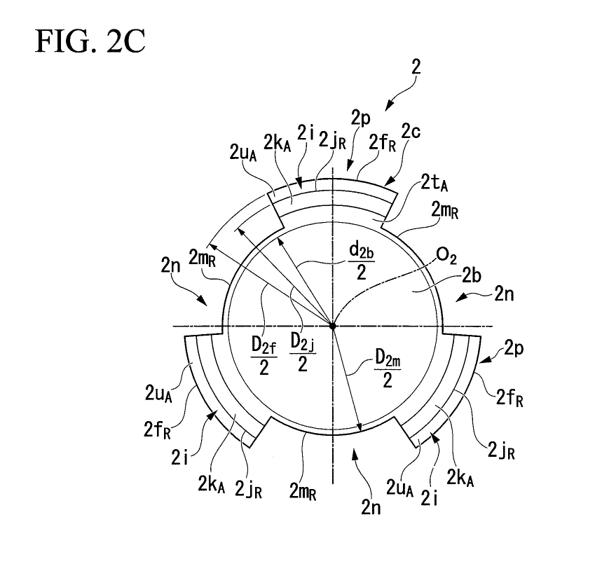

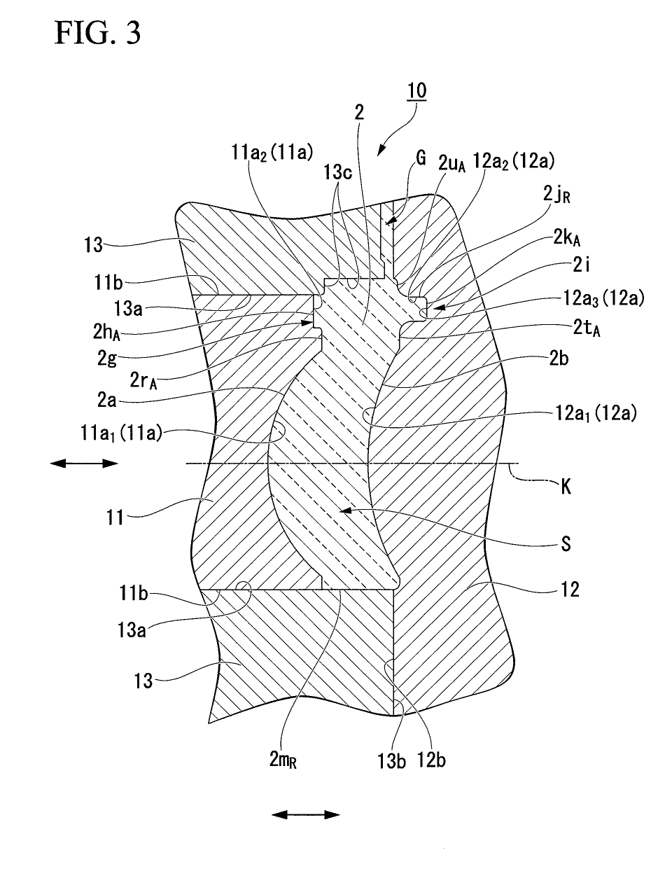

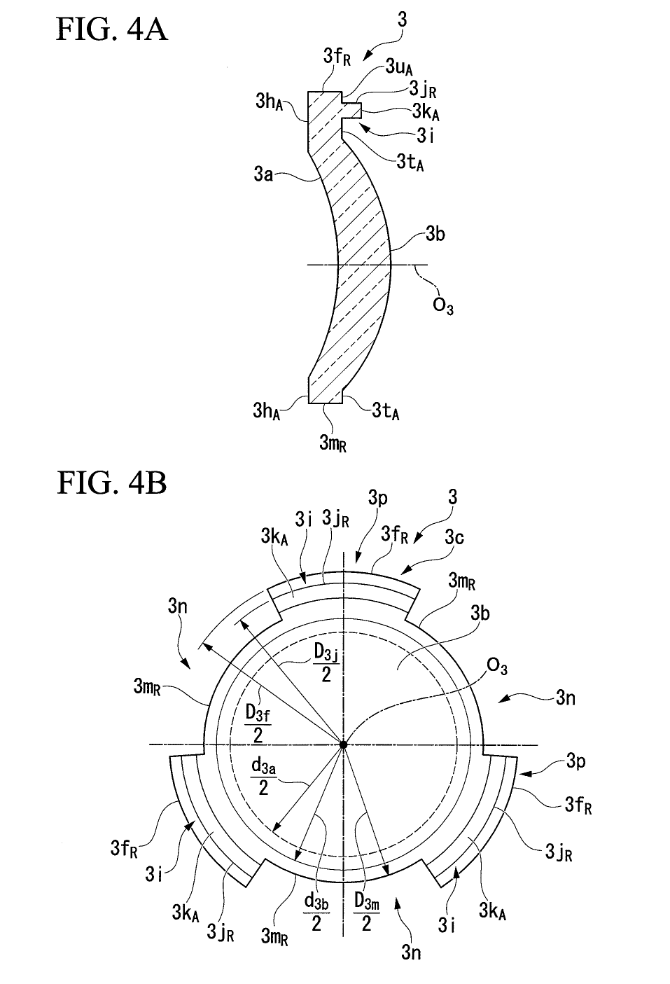

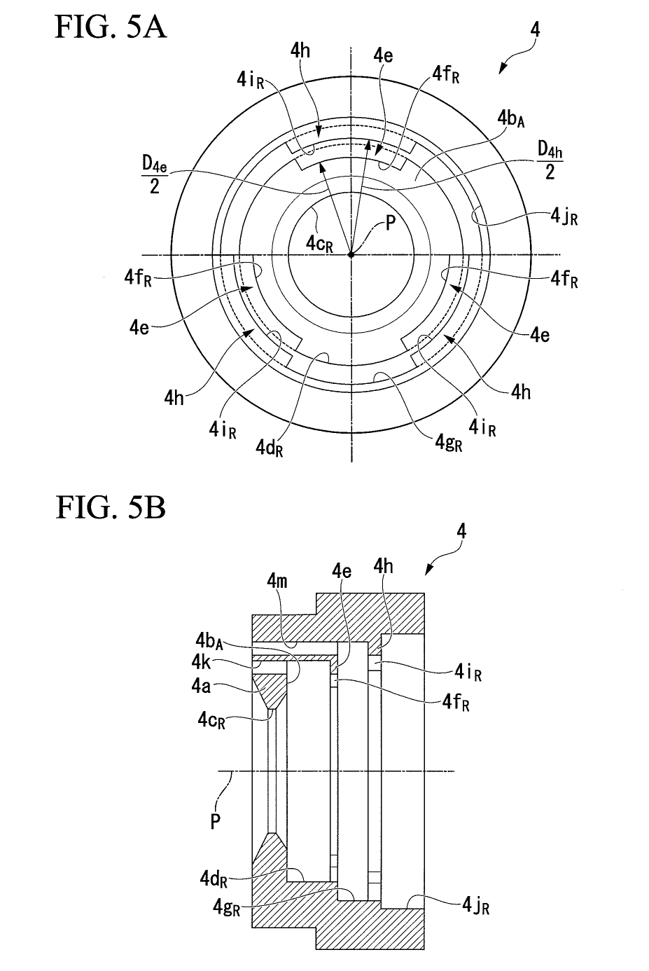

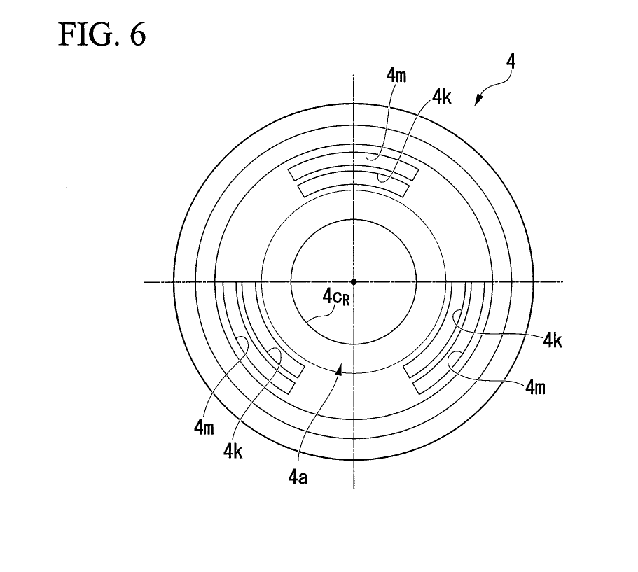

FIG. 1A is a cross-sectional view including optical axes schematically showing an example of the lens unit of the first embodiment of the present invention. FIG. 1B is a right side view including the optical axes schematically showing the example of the lens unit of the first embodiment of the present invention. FIG. 2A is a left side view schematically showing a first lens of the lens unit of the first embodiment of the present invention. FIG. 2B is a cross-sectional view including an optical axis schematically showing the first lens of the lens unit of the first embodiment of the present invention. FIG. 2C is a right side view schematically showing the first lens of the lens unit of the first embodiment of the present invention. FIG. 3 is a cross-sectional view schematically showing the structure of a molding tool of manufacturing the first lens of the first embodiment of the present invention. FIG. 4A is a cross-sectional view including an optical axis schematically showing a second lens of the lens unit of the first embodiment of the present invention. FIG. 4B is a right side view including the optical axis schematically showing the second lens of the lens unit of the first embodiment of the present invention. FIG. 5A is a schematic right side view of a lens holding frame of the lens unit of the first embodiment of the present invention. FIG. 5B is a cross-sectional view including a schematic central axis of the lens holding frame of the lens unit of the first embodiment of the present invention. FIG. 6 is a schematic left side view of the lens holding frame of the lens unit of the first embodiment of the present invention.

In the present description, when positions relative to members, such as shaft-shaped or tubular members, which can specify axes, such as optical axes and central axes, are described, a direction along an axis is referred to as an axial direction, a direction around the axis is referred to as a circumferential direction, and a direction along a line intersecting the axis in a plane orthogonal to the axis is referred to as a radial direction. Additionally, particularly, a direction along an optical axis may be referred to as an optical axis direction. Additionally, a side away from the axis may be referred to outward (outside) in the radial direction, and a side approaching the axis is referred to as inward (inside) in the radial direction.

A lens unit 1 of the present embodiment, as shown in FIGS. 1A and 1B, includes a first lens 2 (lens), a second lens 3 (lens), and a lens frame 4 (lens holding frame).

Within the lens unit 1, the first lens 2 is positioned such that an optical axis O₂ thereof is substantially aligned with a unit central axis P of the lens frame 4 (also including a case where the optical axis is aligned with the unit central axis), and is positioned so as to be pressed in the axial direction of the lens frame 4.

Additionally, the second lens 3 is positioned such that an optical axis O₃ thereof is substantially aligned with the unit central axis P (also including a case where the optical axis is aligned with the unit central axis), and is allowed to abut the first lens 2 and thereby positioned in the optical axis direction. Additionally, in this state, the relative positions of the second lens 3 and the lens frame 4 are fixed by a bonding portion 6.

The bonding portion 6 is formed, for example, by curing an adhesive, such as a UV curable adhesive, a two-liquid adhesive, or a thermosetting adhesive.

The first lens 2 is one of a pair of lenses held by the lens unit 1. In the present embodiment, the first lens 2, as shown in FIGS. 2A, 2B, and 2C, has a first lens surface 2a (lens surface portion) including a convex surface, and a second lens surface 2b (lens surface portion) including a concave surface. Additionally, the first lens 2 is a meniscus lens that has a flange portion 2c provided on an outer peripheral side thereof.

The positive/negative refractive power of the first lens 2 can be appropriately set according to the design specification based on the application of the lens unit 1.

Additionally, the first lens surface 2a is formed within a range of a diameter d₂ₐ centered on the optical axis O₂. Additionally, the second lens surface 2b is formed within a range of a diameter d_{2b} centered on the optical axis O₂.

The first lens surface 2a and the second lens surface 2b constitute a lens surface portion of end surfaces at both ends in a direction along the optical axis O₂.

Although the first lens 2 may be formed by cutting and grinding a glass material, the first lens is formed by mold molding of a synthetic resin in the present embodiment. It should be noted herein that illustration of draft angles is appropriately omitted in the drawing. Additionally, in the following description, description will be made with a shape in a case where the draft angles are ignored. The dimensions of a hole and a shaft that fit to each other are dimensions within ranges to be used for fitting or insertion unless otherwise mentioned, and the dimensions indicate the minimum dimensions for the hole and a maximum dimension for the shaft so that fitting is not hindered even if there are draft angles.

The flange portion 2c is a plate-shaped portion that extends outward in the radial direction from outer peripheries of the first lens surface 2a and the second lens surface 2b, and a convex portion 2p and a concave portion 2n with a smaller external diameter rather than the convex portion 2p are formed alternately in the circumferential direction.

In the present embodiment, three convex portions 2p and three concave portions 2n are provided at positions that equally divide the circumferential direction. As for ranges in the circumferential direction where the convex portion 2p and the concave portion 2n are formed, the convex portion 2p is within a range of a central angle of less than 60°, and the concave portion 2n is within a range exceeding a central angle of 60°.

An outer peripheral surface 2m_{R} that is an outermost surface of the concave portion 2n in the radial direction is formed as a cylindrical surface with a radius D₂ₘ/2 (here, D₂ₘ>d₂ₐ, D₂ₘ>d_{2b}) centered on the optical axis O₂.

A lens side surface 2f_{R} that is a radial outermost surface of the convex portion 2p is formed as a cylindrical surface with a radius D_{2f}/2 (here, D_{2f}>D₂ₘ) centered on the optical axis O₂, and constitutes a radial outermost surface of the first lens 2.

A first inner peripheral flange surface 2r_{A} is formed from the inner peripheral side toward the outer peripheral side as a lens outer edge formed on the outer peripheral side of the lens surface portion, on the surface of the flange portion 2c on the side of the first lens surface 2a. A first outer peripheral flange surface 2s_{A} that is also the lens outer edge is particularly formed closer to the outer peripheral side of each convex portion 2p than the first inner peripheral flange surface 2r_{A}. Additionally in each convex portion 2p, a first projection 2g, which protrudes in the optical axis direction from the first inner peripheral flange surface 2r_{A} and the first outer peripheral flange surface 2s_{A}, is formed between the first inner peripheral flange surface 2r_{A}, and the first outer peripheral flange surface 2s_{A}. The lens outer edge includes the first projection 2g.

The first inner peripheral flange surface 2r_{A} is a surface that is adjacent to an outer periphery of the first lens surface 2a and extends in a direction intersecting the optical axis O₂, and is provided in each concave portion 2n and each convex portion 2p. In the present embodiment, the first inner peripheral flange surface 2r_{A} is a plane orthogonal to the optical axis O₂.

The outer shape of the first projection 2g as seen from the optical axis direction, as shown in FIG. 2A, is a circular-arc belt shape centered on the optical axis O₂.

Additionally, a first abutting surface 2h_{A} (optical-axis-direction positioning portion) aligned with one plane orthogonal to the optical axis O₂ is formed at the tip of each first projection 2g in a protruding direction. That is, the first abutting surface 2h_{A} is provided within the one plane orthogonal to the optical axis O₂.

The position of the first abutting surface 2h_{A} in the optical axis direction is in a fixed positional relationship with respect to the first lens surface 2a. For this reason, the first abutting surface 2h_{A} configures the optical-axis-direction positioning portion of the first lens 2.

The first outer peripheral flange surface 2s_{A} is a surface that extends in the direction intersecting the optical axis O₂ between the first projection 2g and the lens side surface 2f_{R} in each convex portion 2p. In the present embodiment, the first outer peripheral flange surface 2s_{A} is a plane orthogonal to the optical axis O₂.

Additionally, the first outer peripheral flange surface 2s_{A} may be a plane aligned with the first inner peripheral flange surface 2r_{A}, or may not be aligned with the first inner peripheral flange surface 2r_{A}.

A second inner peripheral flange surface 2t_{A} is formed from the inner peripheral side toward the outer peripheral side as the lens outer edge formed on the outer peripheral side of the lens surface portion, on the surface of the flange portion 2c on the side of the second lens surface 2b. A second outer peripheral flange surface 2u_{A} that is also the lens outer edge is formed particularly closer to the outer peripheral side of each convex portion 2p than the second inner peripheral flange surface 2t_{A}. Additionally, in each convex portion 2p, a second projection 2i (positioning projection), which protrudes in the optical axis direction from the second inner peripheral flange surface 2t_{A} and the second outer peripheral flange surface 2u_{A}, is formed between the second inner peripheral flange surface 2t_{A} and the second outer peripheral flange surface 2u_{A}. The lens outer edge includes the second projection 2i.

The second inner peripheral flange surface 2t_{A} is a surface that is adjacent to an outer periphery of the second lens surface 2b and extends in the direction intersecting the optical axis O₂, and is provided in each concave portion 2n and each convex portion 2p. In the present embodiment, the second inner peripheral flange surface 2t_{A} is a plane orthogonal to the optical axis O₂.

The outer shape of the second projection 2i as seen from the optical axis direction, as shown in FIG. 2C, is a circular-arc belt shape centered on the optical axis O₂, and a reference cylindrical surface 2j_{R} (radial positioning portion), which is a cylindrical surface with a radius D₂ⱼ/2 centered on the optical axis O₂, is formed on an outer peripheral portion of the second projection.

The reference cylindrical surface 2j_{R} preferably has a smaller draft angle than the draft angles of the other regions when having the draft angle, and is more preferably a straight surface that does not have the draft angle.

The respective second projections 2i are formed at positions that equally divide the circumferential direction into three corresponding to the arrangement position of the flange portion 2c. For this reason, if each reference cylindrical surface 2j_{R} is internally fitted to a cylindrical surface with a diameter D₂ⱼ, the optical axis O₂ is aligned with a central axis of the cylindrical surface, and radial positioning of the first lens 2 with respect to the cylindrical surface is allowed.

Additionally, a second abutting surface 2k_{A} (optical-axis-direction positioning portion) aligned with one plane orthogonal to the optical axis O₂ is formed at the tip of each second projection 2i in a protruding direction. That is, the second abutting surface 2k_{A} is provided within the one plane orthogonal to the optical axis O₂.

The position of the second abutting surface 2k_{A} in the optical axis direction is in a fixed positional relationship with respect to the second lens surface 2b, and, for this reason, constitutes another optical-axis-direction positioning portion of the first lens 2.

Additionally, by virtue of such a configuration, the respective second abutting surfaces 2k_{A} are aligned with a plane parallel to a plane in which the respective first abutting surfaces 2h_{A} are aligned, and are spaced apart by a fixed distance in the optical axis direction.

The second outer peripheral flange surface 2u_{A} is a surface that extends in the direction intersecting the optical axis O₂ between the second projection 2i and the lens side surface 2f_{R} in each convex portion 2p. In the present embodiment, the second outer peripheral flange surface 2u_{A} is a plane orthogonal to the optical axis O₂.

Additionally, the second outer peripheral flange surface 2u_{A} may be a plane aligned with the second inner peripheral flange surface 2t_{A}, or may not be aligned with the second inner peripheral flange surface 2t_{A}.

By virtue of such a configuration, the reference cylindrical surface 2j_{R} protrudes in the direction along the optical axis O₂ from a position closer to the inner peripheral side than the lens side surface 2f_{R} on one side of the lens outer edge, and constitutes the radial positioning portion provided in a fixed positional relationship with the optical axis O₂ in a direction orthogonal to the optical axis O₂.

Here, an example of the configuration of a molding tool that manufactures the first lens 2 will be described.

The first lens 2, as shown in FIG. 3, can be manufactured by molding using a molding tool assembly 10 including a molding tool member 11 (first molding tool member) and a molding tool member 13 (third molding tool member) that constitute a cavity mold, and a molding tool member 12 (second molding tool member) that constitutes a core mold.

In the molding tool assembly 10, a draft direction is a direction along the optical axis O₂ of the first lens 2.

The molding tool member 11 is a member serving as a movable insert mold of the molding tool member 13 to be described below, and has a molding surface portion 11 a that transfers the shapes of the first lens surface 2a, the first inner peripheral flange surface 2r_{A}, and the first projection 2g, on a tip side facing a molding space S. Additionally, the molding tool member 11 has a mold sliding surface 11b, which fits to the molding tool member 13 and advances/retreats in the draft direction, on a side surface of the molding tool member 11.

For this reason, a lens molding surface 11a₁ that transfers the shape of the first lens surface 2a, and an axial positioning portion molding surface 11a₂ that transfers the surface of the first abutting surface 2h_{A} of the first projection 2g are formed as a series of surfaces on the molding surface portion 11a. Accordingly, the position of the axial positioning portion molding surface 11a₂ with respect to the top of the lens molding surface 11a₁ is kept constant. Additionally, the positional relationship of the axial positioning portion molding surface 11a₂ with respect to the top of the lens molding surface 11a₁ can be finished with high precision by performing mold correction when the molding tool member 11 is manufactured.

The molding tool member 12 has a molding surface portion 12a, which transfers the shapes of the second lens surface 2b, the second inner peripheral flange surface 2t_{A}, the second projection 2i, and the second outer peripheral flange surface 2u_{A}, on the tip side facing the molding space S. The molding tool member 12 has a mold matching surface 12b, which abuts against the molding tool member 13 to be described below, on the outer peripheral side of this molding surface portion 12a.

For this reason, a lens molding surface 12aᵢ that transfers the shape of the second lens surface 2b, a radial positioning portion molding surface 12a₂ that transfers the shape of the reference cylindrical surface 2j_{R} of the second projection 2i, and an axial positioning portion molding surface 12a₃ that transfers the shape of the second abutting surface 2k_{A} of the second projection 2i are formed as a series of surfaces on the molding surface portion 12a. Accordingly, the radial positioning portion molding surface 12a₂ and the axial positioning portion molding surface 12a₃, and the positions with respect to the top of the lens molding surface 12a₁ and the positions and postures thereof with respect to the optical axis O₂ are kept constant. Additionally, the positional relationship of the radial positioning portion molding surface 12a₂ and the axial positioning portion molding surface 12a₃ with respect to the top of the lens molding surface 12a₁ can be finished with high precision by performing mold correction when the molding tool member 12 is manufactured.

It is preferable that the radial positioning portion molding surface 12a₂ have a straight shape that does not provide a draft angle or have as a slope smaller than the draft angles of the other regions.

The molding tool member 13 has a mold sliding surface 13a that constitutes a hole that slidably holds the molding tool member 11, an outer peripheral portion molding surface 13c that transfers the shapes of the first outer peripheral flange surface 2s_{A} and the lens side surface 2f_{R}, and a mold matching surface 13b that abuts against the mold matching surface 12b of the molding tool member 12.

Additionally, the outer peripheral portion molding surface 13c is provided with a gate portion G that introduces molding resin into the molding space S.

The molding tool assembly 10 having such a configuration is aligned so that the respective central axes of the lens molding surfaces 11a₁ and 12a₁ that form the optical axis O₂ can achieve eccentricity tolerance as a predetermined lens single body.

As shown in FIG. 3, the molding space S corresponding to the outer shape of the first lens 2 is formed in a state where the mold is closed. The first lens 2 can be molded by introducing molding resin (molding material) into the space S from the gate portion G and performing molding.

In such a case, the positional relationship between the first lens surface 2a and the first abutting surface 2h_{A} in a molded product can be maintained with high precision by forming the molding surface portion 11a with the lens molding surface 11a₁ and the axial positioning portion molding surface 11a₂.

Additionally, the positional relationship among the second lens surface 2b, the reference cylindrical surface 2j_{R}, and the second abutting surface 2k_{A} in the molded product is maintained with high precision by forming the molding surface portion 12a with the lens molding surface 12a₁, the radial positioning portion molding surface 12a₂, and the axial positioning portion molding surface 12a₃.

Next, the second lens 3 will be described.

The second lens 3, as shown in FIG. 1A, is the other of the pair of lenses, which is coaxially arranged to face the second lens surface 2b of the first lens 2 and is held by the lens unit 1.

In the present embodiment, the second lens 3, as shown in FIG. 4A and FIG. 4B, is a meniscus lens that has a first lens surface 3a (lens surface portion) including a concave surface, and a second lens surface 3b (lens surface portion) including a convex surface and has a flange portion 3c on an outer peripheral side thereof.

The positive/negative refractive power of the second lens 3 can be appropriately set according to the design specification based on the application of the lens unit 1.

Additionally, the first lens surface 3a is formed within a range of a diameter d₃ₐ centered on the optical axis O₃. Additionally, the second lens surface 3b is formed within a range of a diameter d_{3b} centered on the optical axis O₃.

The first lens surface 3a and the second lens surface 3b constitute a lens surface portion of end surfaces at both ends in a direction along the optical axis O₃.

Although the second lens 3, similar to the first lens 2, may be formed by cutting and grinding a glass material, the second lens is formed by mold molding of a synthetic resin in the present embodiment.

The flange portion 3c is a plate-shaped portion that extends outward in the radial direction from outer peripheries of the first lens surface 3a and the second lens surface 3b. A convex portion 3p with a maximum external diameter of the second lens 3 and a concave portion 3n with a smaller external diameter of the convex portion 3p are alternately formed in the circumferential direction on the second lens 3.

In the present embodiment, similar to the first lens 2, three convex portions 3p and three concave portions 3n are provided at positions that equally divide the circumferential direction. As for ranges in the circumferential direction where the convex portion 3p and the concave portion 3n are formed, the convex portion 3p is within a range of a central angle of less than 60°, and the concave portion 3n is within a range exceeding a central angle of 60°.

An outer peripheral surface 3m_{R} that is a radial outermost surface of the concave portion 3n is formed as a cylindrical surface with a radius D₃ₘ/2 (here, D₃ₘ>d₃ₐ, D₃ₘ>d_{3b}) centered on the optical axis O₃.

A lens side surface 3f_{R} that is a radial outermost surface of the convex portion 3p is formed as a cylindrical surface with a radius D_{3f}/2 (here, D_{3f}>D₃ₘ) centered on the optical axis O₃, and constitutes a radial outermost surface of the second lens 3.

Additionally, the flange portion 3c configures a lens outer edge formed on an outer peripheral side of the lens surface portion.

Although the diameter D_{3f} of the outermost surface of the second lens 3 is not particularly limited, in the present embodiment, a case where this diameter is larger than the diameter D_{2f} of the outermost surface of the first lens 2 will be described as an example.

A first flange surface 3h_{A} (optical-axis-direction positioning portion), which is a plane that extends in a direction orthogonal to the optical axis O₃, is formed on the surface of the flange portion 3c on the side of the first lens surface 3a.

The first flange surface 3h_{A}, as shown in FIG. 1A, is provided at a position where the second abutting surface 2k_{A} of the first lens 2 is able to abut the first flange surface when being mounted on the lens frame 4.

The position of the first flange surface 3h_{A} in the optical axis direction is in a fixed positional relationship with respect to the first lens surface 3a. For this reason, the first flange surface 3h_{A} constitutes the optical-axis-direction positioning portion of the second lens 3.

As shown in FIG. 4A and FIG. 4B, a second inner peripheral flange surface 3t_{A} is formed from the inner peripheral side toward the outer peripheral side as the lens outer edge formed on the outer peripheral side of the lens surface portion, on the surface of the flange portion 3c on the side of the second lens surface 3b, and a second outer peripheral flange surface 3u_{A} that is similarly the lens outer edge is formed particularly closer to the outer peripheral side of each convex portion 3p than the second inner peripheral flange surface 3t_{A}. Additionally, in each convex portion 3p, a projection 3i (positioning projection), which protrudes in the optical axis direction from the second inner peripheral flange surface 3t_{A} and the second outer peripheral flange surface 3u_{A}, is formed between the second inner peripheral flange surface 3t_{A} and the second outer peripheral flange surface 3u_{A}.

The second inner peripheral flange surface 3t_{A} is a surface that is adjacent to an outer periphery of the second lens surface 3b and extends in the direction intersecting the optical axis O₃, and is provided in each concave portion 3n and each convex portion 3p. In the present embodiment, the second inner peripheral flange surface 3t_{A} is a plane orthogonal to the optical axis O₃.

The outer shape of the projection 3i as seen from the optical axis direction, as shown in FIG. 4B, is a circular-arc belt shape centered on the optical axis O₃, and a reference cylindrical surface 3j_{R} (radial positioning portion), which is a cylindrical surface with a radius D₃ⱼ/2 centered on the optical axis O₃, is formed on an outer peripheral portion of the projection.

The reference cylindrical surface 3j_{R} preferably has a smaller draft angle than the draft angles of the other regions when having the draft angle, and is more preferably a straight surface that does not have the draft angle.

The respective projections 3i are formed at positions that equally divide the circumferential direction into three corresponding to the arrangement position of the flange portion 3c. For this reason, if each reference cylindrical surface 3j_{R} is internally fitted to a cylindrical surface with a diameter D₃ⱼ, the optical axis O₃ is aligned with a central axis of the cylindrical surface, and radial positioning of the second lens 3 with respect to the cylindrical surface is allowed.

Additionally, a tip surface 3k_{A} aligned with one plane orthogonal to the optical axis O₃ is formed at the tip of each projection 3i in a protruding direction. In the present embodiment, since the tip surface 3k_{A} is not used as an abutting surface for positioning or the like, each tip surface 3k_{A} may not be aligned with the one plane. For this reason, the second lens 3 is an example in a case where the optical-axis-direction positioning portion is provided only on one end surface in the optical axis direction.

However, if the tip surface 3k_{A} is aligned with the one plane orthogonal to the optical axis O₃ similar to the second abutting surface 2k_{A} of the first lens 2, it is also possible to use the tip surface as the optical-axis-direction positioning portion for positioning the tip surface 3k_{A} in the optical axis direction.

The second outer peripheral flange surface 3u_{A} is a surface that extends in the direction intersecting the optical axis O₃ between the projection 3i and the lens side surface 3f_{R} in each convex portion 3p. In the present embodiment, the second outer peripheral flange surface 3u_{A} is a plane orthogonal to the optical axis O₃.

Additionally, the second outer peripheral flange surface 3u_{A} may be a plane aligned with the second inner peripheral flange surface 3t_{A}, or may not be aligned with the second inner peripheral flange surface 3t_{A}.

By virtue of such a configuration, the reference cylindrical surface 3j_{R} protrudes in the direction along the optical axis O₃ from a position closer to the inner peripheral side than the lens side surface 3f_{R} on one side of the lens outer edge, and constitutes the radial positioning portion provided in a fixed positional relationship with the optical axis O₃ in the direction orthogonal to the optical axis O₃.

In this way, the second lens 3 has almost the same outer shape except that the dimension of the second lens is different from the dimension of the first lens 2, the irregularities of the first lens surface 3a and the second lens surface 3b are different from each other, and the second lens includes the first flange surface 3h_{A} instead of the first projection 2g.

For this reason, molding can be performed by the configuration of the same molding tool as the first lens 2.

The lens frame 4 is a lens holding frame mounting the first lens 2 and the second lens 3, as shown in FIG. 5A and FIG. 5B, is a tubular member having a through-hole at a central portion thereof, and includes a lens receiving portion 4a, which holds the first lens 2 in the optical axis direction, at one end in the axial direction. The lens receiving portion 4a is constituted by a plate-shaped portion that extends radially inward from the outer peripheral side of the lens frame 4, and an opening 4c_{R} that ensures a beam passing region for the first lens 2 is formed coaxially with the unit central axis P.

An optical-axis-direction receiving surface 4b_{A} (optical-axis-direction reference surface) including a plane orthogonal to the unit central axis P is provided at the other end of the lens receiving portion 4a in the axial direction within a range where the receiving surface is able to abut the first abutting surface 2h_{A} of the first lens 2.

Additionally, a first lens accommodation hole 4d_{R}, a second lens accommodation hole 4g_{R}, and an opening 4j_{R} including a substantially cylindrical hole with a larger diameter sequentially toward the other end in the axial direction are formed on the outer peripheral side of optical-axis-direction receiving surface 4b_{A}.

The first lens accommodation hole 4d_{R} has a larger diameter than the maximum external diameter D_{2f} of the first lens 2, and the axial length thereof with respect to the optical-axis-direction receiving surface 4b_{A} is larger than the distance from the first abutting surface 2h_{A} of the first lens 2 to the second outer peripheral flange surface 2u_{A}.

If the size of the diameter of the first lens accommodation hole 4d_{R} has, for example, such a dimension that molding burrs that may be generated in the first lens 2 do not abut the first lens accommodation hole, then the burr elimination work of the first lens 2 can be simplified, which is preferable.

By virtue of such a configuration, it is possible to accommodate the first lens 2 inside the first lens accommodation hole 4d_{R} without causing the abutment therebetween in the radial direction and in the axial direction.

The diameter of the second lens accommodation hole 4g_{R} is larger than the maximum external diameter D_{3f} of the second lens 3. The axial length of the second lens accommodation hole 4g_{R} is larger than the distance from the first flange surface 3h_{A} to the second outer peripheral flange surface 3u_{A}. Additionally, as shown in FIG. 1A, the axial position of second lens accommodation hole 4g_{R} is a position where the lens side surface 3f_{R} faces an axial intermediate portion of the second lens accommodation hole 4g_{R}, in a state where the second lens 3 is positioned in the axial direction with respect to the first lens 2.

The size of the diameter of the second lens accommodation hole 4g_{R}, similar to the first lens accommodation hole 4d_{R}, preferably has such a dimension that molding burrs of the second lens 3 do not abut the second lens accommodation hole.

By virtue of such a configuration, it is possible to accommodate the second lens 3 inside the second lens accommodation hole 4g_{R} without causing the abutment therebetween in the radial direction and in the axial direction.

The opening 4j_{R} is an opening at the other end of the lens frame 4 and can be made to have an appropriate size that ensures a beam passing region for the second lens 3. In the present embodiment, the opening 4j_{R} is configured by a cylindrical surface with a larger diameter than the second lens accommodation hole 4g_{R}.

Circular-arc plate-shaped lens fitting portions 4e that extend radially inward are provided at three positions corresponding to the three flange portions 2c of the first lens 2 between the first lens accommodation hole 4d_{R} and the second lens accommodation hole 4g_{R}. In the present embodiment, the circumferential range of each lens fitting portion 4e is provided within a range of a central angle of 60°.

Additionally, in order to internally fit each reference cylindrical surface 2j_{R} of the first lens 2 to position the first lens 2 in the radial direction, a radial positioning surface 4f_{R} including a cylindrical surface with a radius D₄e/2 centered on the unit central axis P is formed on an inner peripheral portion of each lens fitting portion 4e. The dimension D₄ₑ is set so as to satisfy the following Formula (1).

D₂ⱼ≦D₄ₑ≦D₂ⱼ+δ₂ (1)

Here, δ₂ is the tolerance of eccentricity caused by the assembling error of the first lens 2, and is, for example, 2 μm.

Additionally, circular-arc plate-shaped lens fitting portions 4h that extend radially inward are provided at three positions corresponding to the three flange portions 3c of the second lens 3 between the second lens accommodation hole 4g_{R} and the opening 4j_{R}. In the present embodiment, the circumferential range of each lens fitting portion 4h is a range of a central angle of 60°, and is the same angle region as that where the lens fitting portion 4e is provided (refer to FIG. 4B).

Additionally, in order to internally fit each reference cylindrical surface 3j_{R} of the second lens 3 to position the second lens 3 in the radial direction, a radial positioning surface 4i_{R} including a cylindrical surface with a radius D₄ₕ/2 centered on the unit central axis P is formed on an inner peripheral portion of each lens fitting portion 4h. The dimension D₄ₕ is set so as to satisfy the following Formula (2).

D₃ⱼ≦D₄ₕ≦D₃ⱼ+δ₃ (2)

Here, δ₃ is the tolerance of eccentricity caused by the assembling error of the second lens 3, and is, for example, 2 μm.

The lens frame 4 can be formed, for example, by cutting of metal or synthetic resin or molding using a metallic material or a synthetic resin material.

Resin mold molding is adopted in the present embodiment. Holes 4k and 4m shown in FIG. 5B and FIG. 6 are holes for not making the lens fitting portions 4e and 4h into undercut shapes, respectively.

In the lens frame 4 of the shape of the present embodiment, molding surfaces that transfer the shapes of the lens receiving portion 4a and the radial positioning surfaces 4f_{R} and 4i_{R} can be formed in a core molding tool. For this reason, since all are molded by molding surfaces formed in the same molding tool member, a mutual positional relationship can be held with high precision.

In order to mount the first lens 2 and the second lens 3 into the lens frame 4 having such a configuration to assemble the lens unit 1 as shown in FIGS. 1A and 1B, first, the first lens 2 is arranged so that the first lens surface 2a faces the opening 4j_{R} and each convex portion 2p is located between the adjacent lens fitting portions 4e of the lens frame 4. Then, the first lens 2 is rotated by about 60° in the circumferential direction after the first lens 2 is inserted toward the optical-axis-direction receiving surface 4b_{A} from the opening 4j_{R} side and the optical-axis-direction receiving surface 4b_{A} is made to abut the first abutting surface 2h_{A}.

Accordingly, the first lens 2 is accommodated in the first lens accommodation hole 4d_{R} in a state where the first abutting surface 2h_{A} abuts against the optical-axis-direction receiving surface 4b_{A} of the lens receiving portion 4a and each convex portion 2p is covered with each lens fitting portion 4e and is prevented from coming off in the axial direction.

At this time, since each reference cylindrical surface 2j_{R} is internally fitted to each lens fitting portion 4e, the first lens 2 is positioned in the radial direction with an arrangement error of δ₂ or less with respect to the unit central axis P.

Next, the second lens 3 is arranged so that the first lens surface 3a faces the opening 4j_{R} and each convex portion 3p is located between the adjacent lens fitting portions 4h of the lens frame 4. Then, the second lens 3 is rotated by about 60° in the circumferential direction after the second lens 3 is inserted toward the second abutting surface 2k_{A} from the opening 4j_{R} side and the first flange surface 3h_{A} is made to abut the second abutting surface 2k_{A}.

Accordingly, the second lens 3 is accommodated in the second lens accommodation hole 4g_{R} in a state where the first flange surface 3h_{A} abuts against the second abutting surface 2k_{A} of the first lens 2 and each convex portion 3p is covered with each lens fitting portion 4h and is prevented from coming off in the axial direction.

At this time, since each reference cylindrical surface 3j_{R} is internally fitted to each lens fitting portion 4h, the second lens 3 is positioned in the radial direction with an arrangement error of δ₃ or less with respect to the unit central axis P.

Next, the positioning in the optical axis direction is performed by pressing the second lens 3 in the axial direction toward the first lens 2 side, making the lens receiving portion 4a and the first abutting surface 2h_{A} abut each other, and making the second abutting surface 2k_{A} and the first flange surface 3h_{A} abut each other in the axial direction.

Next, with this state held, the bonding portion 6 is formed by coating and curing an adhesive so as to spread over each projection 3i and the lens fitting portion 4h.

In the present embodiment, the bonding portion 6 is formed at the central portions of each projection 3i and each lens fitting portion 4h in the circumferential direction in FIG. 1B. However, the coating shape and number of bonding portions 6 can be appropriately changed according to required bonding strength. For example, a plurality of bonding portions may be formed on one projection 3i and one lens fitting portion 4h so as to be spaced apart in the circumferential direction, or a bonding portion may be formed in the shape of a circular arc along the circumferential direction.

In this way, the lens unit 1 is assembled.

According to the lens unit 1, the lens spacing between the first lens 2 and the second lens 3 is determined according to the positional precision of the first abutting surface 2h_{A} of the second projection 2i and the first flange surface 3h_{A}.

In the present embodiment, the first abutting surface 2h_{A} (first flange surface 3h_{A}) is molded by the same molding tool member (the above-described molding tool member 12 in the case of the first lens 2) having the molding surface that transfers the shape of the second lens surface 2b (first lens surface 3a). Therefore, the positional relationship in which positioning is precisely performed when the molding tool member is manufactured can be held, and dimensional variations in every molding can be reduced.

For this reason, since the lens spacing between the second lens surface 2b and the first lens surface 3a is determined only by the part precision of the first lens 2 and the second lens 3 via the lens frame 4, the assembling errors can be reduced even if assembling is performed without adjustment.

Additionally, the eccentricities caused by the assembling errors of the first lens 2 and the second lens 3 are determined depending on a fitting gap between the reference cylindrical surface 2j_{R} and the radial positioning surface 4f_{R} and a fitting gap between the reference cylindrical surface 3j_{R} and the radial positioning surface 4i_{R}.

In the present embodiment, the reference cylindrical surface 2j_{R} (reference cylindrical surface 3j_{R}) is molded by the same molding tool member (the above-described molding tool member 12 in the case of the first lens 2) having the molding surface that transfers the shape of the second lens surface 2b (second lens surface 3b). Therefore, the positional relationship in which positioning is precisely performed when the molding tool member is manufactured can be held, and dimensional variations in every molding can be reduced.

For this reason, even if assembling is performed without adjustment, the eccentricities can be made to fall within fixed tolerances or less.

For comparison with an example that is different from the present embodiment, for example, in the first lens 2, a case where radial positioning is performed using the lens side surface 2f_{R} whose shape is transferred by the molding surface formed on the molding tool member 13 will be considered. In this case, the lens surface portion and the radial positioning portion are formed by molding surfaces on separate molding tool members, and the molding tool members move relative to each other. Therefore, the positional precision of the lens side surface 2f_{R} with respect to the first lens surface 2a and the second lens surface 2b will deteriorate.

That is, the molding tool member 11 molding the first lens surface 2a and the molding tool member 12 molding the second lens surface 2b suppress the eccentricity between the first lens surface 2a and the second lens surface 2b, and are aligned with each other with high precision. However, since the molding tool member 13 molding the lens side surface 2f_{R} needs to slidingly move with respect the molding tool member 11, particularly the positional precision in the radial direction will vary within a range of a sliding gap. For this reason, if the lens side surface 2f_{R} is used as a radial positioning portion, variations in eccentricity will increase.

In contrast, in the present embodiment, variations in eccentricity by such causes do not occur.

Additionally, in the present embodiment, the first lens accommodation hole 4d_{R} and the second lens accommodation hole 4g_{R} are provided in the lens frame 4 with such sizes that these holes do not abut the convex portions 2p and 3P during assembling. Therefore, the shape errors of the first inner peripheral flange surface 2r_{A}, the first outer peripheral flange surface 2s_{A}, the lens side surface 2f_{R}, the second inner peripheral flange surface 2t_{A}, the second outer peripheral flange surface 2u_{A}, the first flange surface 3h_{A}, the lens side surface 3f_{R}, the second inner peripheral flange surface 3t_{A}, and the second outer peripheral flange surface 3u_{A} do not influence the assembling errors.

In this way, according to the first lens 2 and the second lens 3, the positioning projection having the radial positioning portion that protrudes parallel to the optical axis from the position closer to the inner peripheral side than the lens side surface is formed. Therefore, the radial positioning portion can be precisely and easily formed compared to the case where the positioning portion is provided on the lens side surface.

Additionally, according to the lens unit 1, the eccentricities can be reduced even without adjustment by fitting the radial positioning portion of the first lens 2 and the second lens 3 to the lens fitting portion of the lens frame 4.

For this reason, the part costs of the first lens 2 and the second lens 3 and the assembling costs of the lens unit 1 can be reduced.

### Modification Example

Next, a lens and a lens unit of a modification example of the present embodiment will be described.

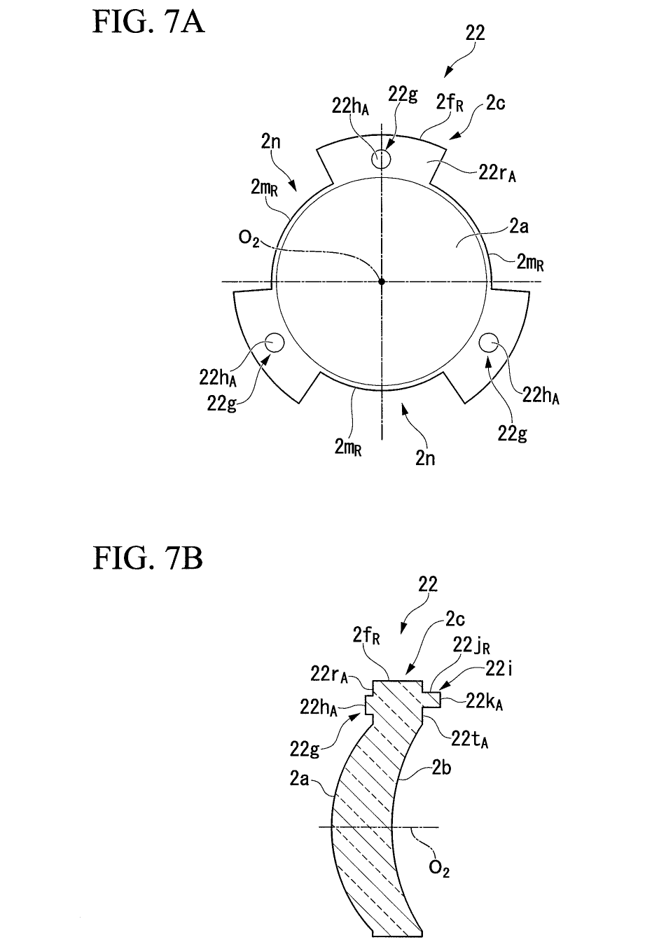

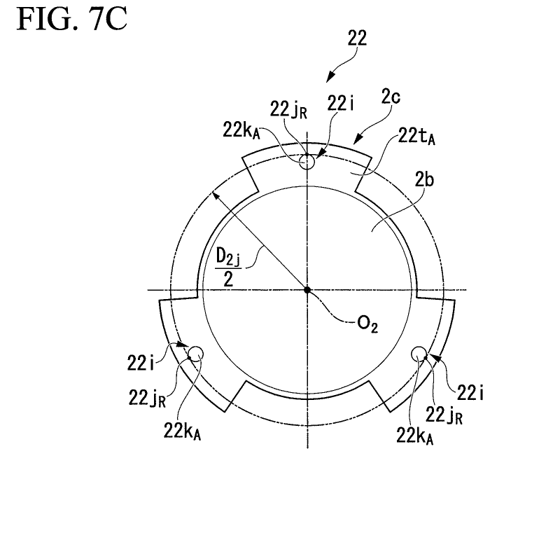

FIGS. 7A, 7B, and 7C are a left side view schematically showing the lens of the modification example of the first embodiment of the present invention, a cross-sectional view including an optical axis, and a right side view, respectively.

As shown in FIGS. 7A, 7B, and 7C, a first lens 22 (lens) of the present modification example includes a first projection 22g and a second projection 22i (positioning projection), instead of the first projection 2g and the second projection 2i of the first lens 2 of the above first embodiment. Along with this, the first lens 22 includes a first flange surface 22r_{A} (lens outer edge) instead of the first inner peripheral flange surface 2r_{A} and the first outer peripheral flange surface 2s_{A}, and includes a second flange surface 22t_{A} (lens outer edge) instead of the second inner peripheral flange surface 2t_{A} and the second outer peripheral flange surface 2u_{A}.

The first lens 22 can be mounted on the lens frame 4 instead of the first lens 2 of the above first embodiment so as to constitute a lens unit 21 of the present modification example as shown in FIG. 1A.

Hereinafter, differences from the above first embodiment will mainly be described.

The first projection 22g is a projection that protrudes from the first flange surface 22r_{A} in which the same plane as the first inner peripheral flange surface 2r_{A} of the above first embodiment extends to the lens side surface 2f_{R}, and has an outer shape that is circular as seen from the optical axis direction. A tip portion of the first projection 22g in a protruding direction is formed with a first abutting surface 22h_{A} (optical-axis-direction positioning portion) whose position in the optical axis direction is made the same as that of the first abutting surface 2h_{A} of the first projection 2g. The position of the first projection 22g on the first flange surface 22r_{A} is not particularly limited if this position is a position where the first projection is able to abut the lens receiving portion 4a. In the present modification example, as an example, the first projection is provided at a position that becomes the circumferential center of the first abutting surface 2h_{A} in the above first embodiment.

The second projection 22i is a projection that protrudes from the second flange surface 22t_{A} in which the same plane as the second inner peripheral flange surface 2t_{A} of the above first embodiment extends to lens side surface 2f_{R}, and has an outer shape that is circular as seen from the optical axis direction.

In each second projection 22i, a reference side surface portion 22j_{R} (radial positioning portion) aligned with an imaginary cylindrical surface with a radius D₂ⱼ/2 centered on the optical axis O₂ is formed on a side surface portion serving as a radial outermost portion.

As in the present embodiment, the reference side surface portion 22j_{R} is a generating line of a column that is in contact with the imaginary cylindrical surface when the second projection 22i is formed in the shape of the column, and has a shape capable of making line contact with the radial positioning surface 4f_{R}.

However, the cross-sectional shape of the second projection 22i is not limited the circular shape, and for example, may be a shape in which a cylindrical surface aligned with the imaginary cylindrical surface is provided on an outer peripheral side surface. In this case, the contact with the radial positioning surface 4f_{R} can be made by the side surface having such a cylindrical surface shape.

Additionally, a second abutting surface 22k_{A} (optical-axis-direction positioning portion) aligned with one plane orthogonal to the optical axis O₂ is formed at the tip of each second projection 22i in a protruding direction, at the same position as the second abutting surface 2k_{A} of the above first embodiment.

According to such a first lens 22, the lens unit 21 can be assembled by being mounted on the lens frame 4 similar to the first lens 2 of the above first embodiment. In that case, the first abutting surface 22h_{A} and the second abutting surface 22k_{A}, similar to the first abutting surface 2h_{A} and the second abutting surface 2k_{A}, constitute the optical-axis-direction positioning portion, and the reference side surface portion 22j_{R}, similar to the reference cylindrical surface 2j_{R}, constitutes the radial positioning portion, and includes the same effects as those of the above first embodiment.

Particularly, in the present modification example, the areas of the first abutting surface 22h_{A} and the second abutting surface 22k_{A} can be made narrower than those of the first abutting surface 2h_{A} and the second abutting surface 2k_{A} of the above first embodiment. Therefore, the positioning in the optical axis direction can be performed in a state nearer to three receiving points. For this reason, higher-precision positioning is allowed.

Additionally, the first projection 22g and the second projection 22i are formed in the shape of a column. Accordingly, mold correction of the molding tool member becomes easier when molding the first lens 22. Therefore, it is easier to manufacture the molding tool member with high precision.

Additionally, by forming the second projection 22i in the shape of a column, line contact is reliably made when the second projection comes into contact with radial positioning surface 4f_{R}. Accordingly, since the radial position is determined by three points in the circumferential direction, high-precision positioning is allowed.

Additionally, since the volume of the second projection 22i can be reduced compared to that of the second projection 2i, the influence on the first lens surface 2a and the second lens surface 2b in terms of molding can be reduced. For this reason, since it is possible to provide the second projection 22i at a position nearer to the second lens surface 2b compared to the second projection 2i, further miniaturization is allowed.

### Second Embodiment

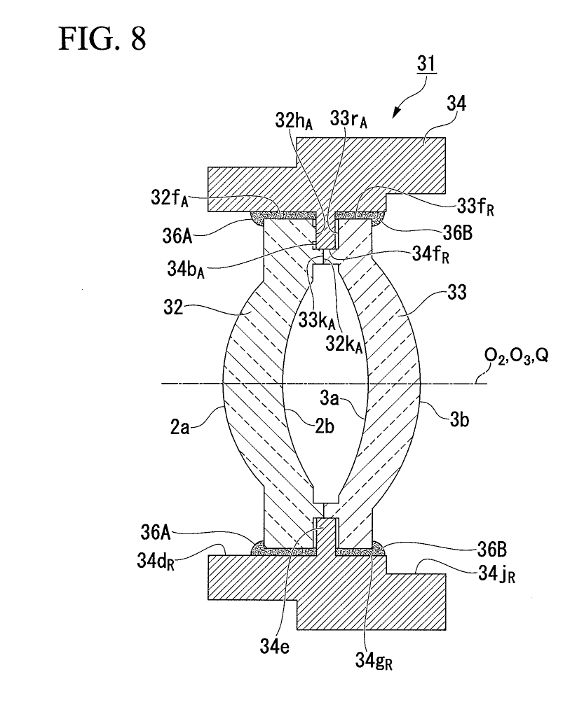

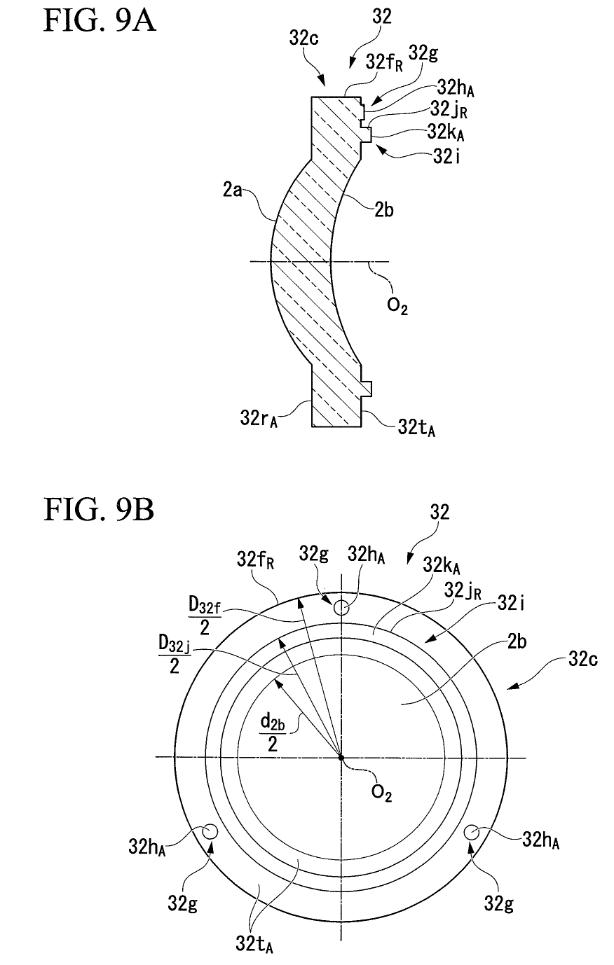

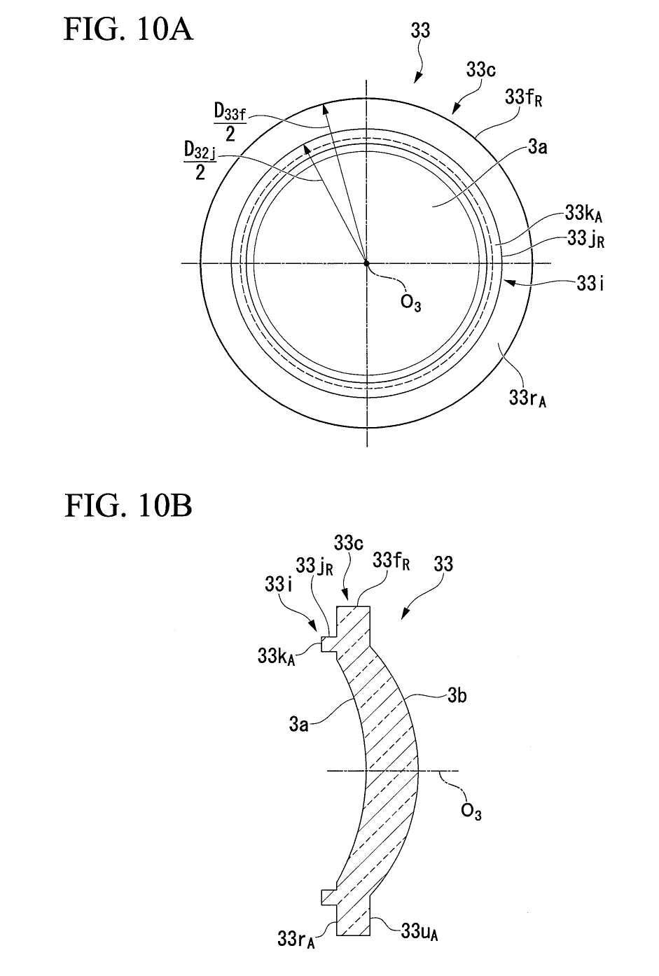

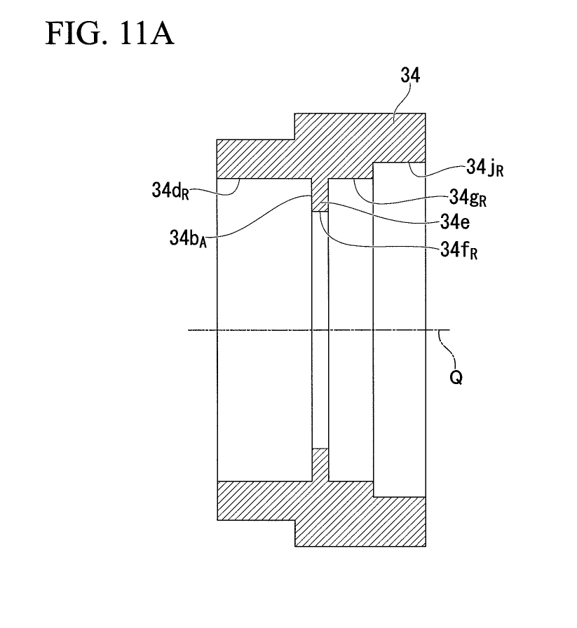

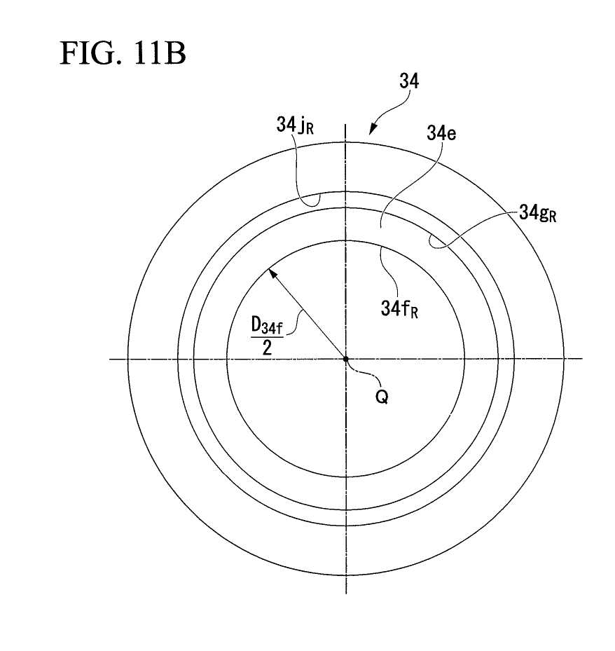

Next, a lens, a lens holding frame, and a lens unit of a second embodiment of the present invention will be described. FIG. 8 is a cross-sectional view including optical axes schematically showing an example of the lens unit of the second embodiment of the present invention. FIGS. 9A and 9B are a cross-sectional view and a right side view including an optical axis schematically showing a first lens of the lens unit of the second embodiment of the present invention, respectively. FIGS. 10A and 10B are a cross-sectional view including an optical axis, and a left side view schematically showing the second lens of the lens unit of the second embodiment of the present invention, respectively. FIGS. 11A and 11B are a cross-sectional view and a schematic right side view including a schematic central axis of the lens holding frame of the lens unit of the second embodiment of the present invention.

As shown in FIG. 8, a lens unit 31 of the present embodiment includes a first lens 32 (lens), a second lens 33 (lens), and a lens frame 34 (lens holding frame), instead of the first lens 2, the second lens 3, and the lens frame 4 of the above first embodiment.

Since the configuration of a lens surface portion of the first lens 32 and the second lens 33 is the same as that of the above first embodiment, the optical axes of the first lens 32 and the second lens 33 are written as the optical axes O₂ and O₃, respectively.

Within the lens unit 31, the first lens 32 is positioned such that the optical axis O₂ thereof is substantially aligned with a unit central axis Q of the lens frame 34 (also including a case where the optical axis is aligned with the unit central axis), and is positioned so as to be pressed against the lens frame 34 in the axial direction.

Additionally, the second lens 33 is positioned such that the optical axis O₃ thereof is substantially aligned with the unit central axis Q (also including a case where the optical axis is aligned with the unit central axis), and is allowed to abut the first lens 32 and thereby positioned in the optical axis direction.

In this state, the respective relative positions of the first lens 32 and the second lens 33 are fixed by bonding portions 36A and 36B formed over respective outermost peripheral portions thereof and an inner peripheral surface of the lens frame 34.

The bonding portions 36A and 36B are formed by curing the same adhesive as the bonding portion 6 of the above first embodiment.

The first lens 32 is one of a pair of lenses held by the lens unit 31, and as shown in FIGS. 9A and 9B, a flange portion 32c, which extends in the shape of a disk, is provided on the outer peripheral side of the lens surface portion constituted by the first lens surface 2a and the second lens surface 2b.

The flange portion 32c is surrounded by a first flange surface 32A that extends radially outward from the outer periphery of the first lens surface 2a, a lens side surface 32f_{R} in the shape of a cylindrical surface that constitutes a radial outermost surface of the first lens 32, and a second flange surface 32t_{A} (lens outer edge) that extends radially outward from the outer periphery of the second lens surface 2b to the lens side surface 32f_{R}.

The lens side surface 32f_{R} includes a cylindrical surface with a radius D_{32f}/2 (here, D_{32f}>d₂ₐ, D_{32f}>d_{2b}) centered on the optical axis O₂.

Additionally, an annular projection 32i (positioning projection) and a columnar projection 32g are provided on the second flange surface 32t_{A}.

The annular projection 32i is a projection provided in order to perform radial positioning with respect to the lens frame 34, and an annular cross-section protrudes in the optical axis direction.

A reference cylindrical surface 32j_{R} (radial positioning portion) that is an outer peripheral surface of the annular projection 32i is a cylindrical surface of which the radius is D₃₂ⱼ/2 (here, d_{2b}<D₃₂ⱼ<D_{32f}) with the optical axis O₂ as a center.

A second abutting surface 32k_{A} (optical-axis-direction positioning portion) aligned with one plane orthogonal to the optical axis O₂ is formed at the tip of the annular projection 32i in a protruding direction.

The second abutting surface 32k_{A} is a region where the positioning of the second lens 33 in the optical axis direction with respect to the first lens 32 is performed by abutting and assembling the second lens 33.

The position of the second abutting surface 32k_{A} in the optical axis direction is a position where the spacing between the second lens surface 2b and the first lens surface 3a can be set to a predetermined lens surface spacing in a relationship with an abutting surface 33k_{A} of the second lens 33 to be described below.

For example, the protruding height with respect to the second flange surface 32t_{A} is preferably a dimension that is about the half of the protruding height of the second projection 2i in the above first embodiment.

The columnar projection 32g is a projection in which the circular cross-section of the columnar projection 32g protrudes in the optical axis direction. The positioning of the first lens 32 in the optical axis direction with respect to the lens frame 34 can be performed by abutting and assembling the columnar projection 32g against the lens frame 34.

In the present embodiment, columnar projections 32g are provided in three places that equally divide the circumferential direction into three parts between the reference cylindrical surface 32j_{R} and the lens side surface 32f_{R} on the second flange surface 32t_{A}.

A first abutting surface 32h_{A} (optical-axis-direction positioning portion), which is aligned with one plane orthogonal to the optical axis O₂ and has a smaller protruding amount in the optical axis direction from the second flange surface 32t_{A} than that of the annular projection 32i, is formed at the tip of each columnar projection 32g in a protruding direction.

The second lens 33 is the other of the pair of lenses held by the lens unit 21, and as shown in FIGS. 10A and 10B, a flange portion 33c, which extends in the shape of a disk, is provided on the outer peripheral side of the lens surface portion constituted by the first lens surface 3a and the second lens surface 3b.

The flange portion 33c is surrounded by a first flange surface 33r_{A} (lens outer edge) that extends radially outward from the outer periphery of the first lens surface 3a, a lens side surface 33f_{R} in the shape of a cylindrical surface that constitutes a radial outermost surface of the second lens 33, and a second flange surface 33t_{A} that extends radially outward from the outer periphery of the second lens surface 3b to the lens side surface 33f_{R}.

The lens side surface 33f_{R} includes a cylindrical surface with a radius D_{33f}/2 (here, D_{33f}>D₃₂ⱼ) centered on the optical axis O₃.

Additionally, an annular projection 33i (positioning projection) is provided on the first flange surface 33r_{A}.

The annular projection 33i is a projection provided in order to perform radial positioning with respect to the lens frame 34, and an annular cross-section protrudes in the optical axis direction.

A reference cylindrical surface 33j_{R} (radial positioning portion) that is an outer peripheral surface of the annular projection 33i is a cylindrical surface of which the radius is D₃₂ⱼ/2 with the optical axis O₃ as a center. That is, in the present embodiment, the external diameters of the reference cylindrical surfaces 32j_{R} is the same as that of the reference cylindrical surfaces 33j_{R}.

An abutting surface 33k_{A} (optical-axis-direction positioning portion) aligned with one plane orthogonal to the optical axis O₃ is formed at the tip of the annular projection 33i in a protruding direction.

The abutting surface 33k_{A} is a region where the positioning of the second lens 33 in the optical axis direction with respect to the first lens 32 is performed by being abutted against and assembled to the second abutting surface 32k_{A} of the first lens 32.

For this reason, the position the second abutting surface 32k_{A} in the optical axis direction is set so that the total of the protruding height of the annular projection 32i of the first lens 32 and the protruding height of the annular projection 33i becomes equal to the protruding height of the second projection 2i of the above first embodiment.

Such first lens 32 and second lens 33 can be manufactured similar to the first lens 2 and the second lens 3 of the above first embodiment.

When being manufactured by molding, at least the molding surfaces of the annular projections 32i and 33i and the molding surfaces of the second lens surface 2b and the first lens surface 3a are preferably formed on the same molding tool member.

The lens frame 34 is a lens holding frame mounting the first lens 32 and the second lens 33. Additionally, the lens frame 34, as shown in FIGS. 11A and 11B, is a tubular member having a through-hole at a central portion thereof, and a first lens accommodation hole 34d_{R} including a cylindrical hole that accommodates the first lens 32, a second lens accommodation hole 34g including a cylindrical hole that accommodates the second lens 33, and a diameter opening 34j_{R} having a larger diameter than the second lens accommodation hole 34g that ensure a beam passing region for the second lens 33 are formed coaxially with the unit central axis Q from one end toward the other end in the axial direction.

The internal diameters of the first lens accommodation hole 34d_{R} and the second lens accommodation hole 34g are larger than external diameters including the lens side surface 32f_{R} and 33f_{R}, respectively.

A lens receiving portion 34e, which protrudes radially inward in order to position the first lens 32 in the optical axis direction and in the radial direction and further to position the second lens 33 in the radial direction, is provided between the first lens accommodation hole 34d_{R} and the second lens accommodation hole 34g.

The lens receiving portion 34e includes an axial receiving surface 34b_{A} (optical-axis-direction reference surface) including a plane orthogonal to the unit central axis Q, at one end in the axial direction, and has a radial positioning surface 34f_{R} internally fitting the reference cylindrical surfaces 32j_{R} and 33j_{R} provided in the axial direction through a central portion thereof.

If the radial positioning surface 34f_{R} can be positioned in the radial direction, a cylindrical surface that is continuous in the circumferential direction, or an appropriate surface that is intermittent in the circumferential direction and is brought into point contact, line contact, or surface contact with the reference cylindrical surfaces 32j_{R} and 33j_{R} can be adopted.

In the present embodiment, a cylindrical surface with a radius D_{34f}/2 centered on the unit central axis Q is used as the radial positioning surface 34f_{R}. The dimension D_{34f} is a value that satisfies the following Formula (3).

D₃₂ⱼ≦D_{34f}≦D₃₂ⱼ+δₘᵢₙ (3)

Here, δₘᵢₙ is the tolerance of the smaller one out of δ₂ and δ₃.

Additionally, the axial thickness dimension of the lens receiving portion 34e, as shown in FIG. 8, is a dimension larger than the distance in the optical axis direction between the first abutting surface 32h_{A} and the first flange surface 33r_{A}, in a state where the second abutting surface 32k_{A} and the abutting surface 33k_{A} abut each other. Such the lens frame 34 can be manufactured similar to the lens frame 4.

In order to mount the first lens 32 and the second lens 33 into the lens frame 34 having such a configuration to assemble the lens unit 31 as shown in FIGS. 8A and 8B, the first lens 32 is inserted into the first lens accommodation hole 34d_{R} of the lens frame 34, and the annular projection 32i is internally fitted to the radial positioning surface 34f_{R}. Accordingly, the optical axis O₂ of the first lens 32 is positioned in the radial direction so as to be substantially aligned with the unit central axis Q of the lens frame 34 (also including a case where the optical axis is aligned with the unit central axis).

At this time, since the reference cylindrical surface 32j_{R} is internally fitted to the radial positioning surface 34f_{R}, the first lens 32 is positioned in the radial direction with the arrangement error of δₘᵢₙ or less with respect to the unit central axis Q.

Moreover, if the insertion of the first lens 32 is continued, the first lens 32 is positioned in the optical axis direction with respect to the lens frame 34 as the first abutting surface 32h_{A} abuts against the axial receiving surface 34b_{A}.

At this time, the second abutting surface 32k_{A} is located at an intermediate portion of the lens receiving portion 34e in the thickness direction.

Next, in a state where this positioning state is held using, for example, a proper holding jig (not shown) or the like, the second lens 33 is inserted from the opening 34j_{R} side, the annular projection 33i is internally fitted to the radial positioning surface 34f_{R}, and the abutting surface 33k_{A} is made to abut the second abutting surface 32k_{A} of the first lens 32.

Accordingly, the second lens 33 is accommodated within the second lens accommodation hole 34g in a state where the second lens is positioned in the optical axis direction with respect to the first lens 32.

At this time, since the reference cylindrical surface 33j_{R} is internally fitted to the radial positioning surface 34f_{R}, the second lens 33 is positioned in the radial direction with the arrangement error of δₘᵢₙ or less with respect to the unit central axis Q. Additionally, the first flange surface 33r_{A} of the second lens 33, and the lens receiving portion 34e are spaced apart from each other.

Next, this state is held, the bonding portion 36A (36B) is formed, as shown in FIG. 8, by coating and curing an adhesive so as to spread over the lens side surface 32f_{R} (33f_{R}) and the first lens accommodation hole 34d_{R} (second lens accommodation hole 34g).

Here, as for the coating method of the bonding portions 36A and 36B, appropriate spotted or linear coating or the like is allowed similar to the bonding portion 6 of the above first embodiment. In this way, the lens unit 31 is assembled.

Although the lens unit 31 is different from the lens unit 1 of the above first embodiment in terms of an insertion direction during assembling, this lens unit includes the first abutting surface 32h_{A}, the second abutting surface 32k_{A}, and the abutting surface 33k_{A} corresponding to the first abutting surface 2h_{A}, the second abutting surface 2k_{A}, and the first flange surface 3h_{A} that are the optical-axis-direction positioning portion of the above first embodiment. Additionally, this lens unit includes the reference cylindrical surfaces 32j_{R} and 33j_{R} corresponding to the reference cylindrical surfaces 2j_{R} and 3j_{R} that are the radial positioning portion of the above first embodiment. For this reason, similar to the above first embodiment, the assembling errors can be reduced even if assembling is performed without adjustment.

Although a case where the lens unit is constituted by the two lenses has been described as an example in the descriptions of the above respective embodiments and modification example, lenses that constitute the lens unit may be one or may be three or more.

When the lens unit is constituted by one lens, one optical-axis-direction positioning portion and one radial positioning portion may be provided at the lens, respectively.

Additionally, when the configuration of three or more lenses is adopted, for example, in the above first embodiment, the respective tip surfaces 3k_{A} of the second lens 3 are formed so as to be aligned with one plane orthogonal to the optical axis O₃, similar to the second abutting surface 2k_{A} of the first lens 2, the positions of the tip surfaces 3k_{A} in the optical axis direction is set in consideration of the distances between lens surfaces with respect to a third lens, and a lens in which the same optical-axis-direction positioning portion and the radial positioning portion as those of the second lens 3 are provided is added. As a result, the lens configuration of three or more lenses can be appropriately supported.

Additionally, in the configuration of the second embodiment, the configuration of three or more lenses can also be easily supported. In this case, a lens sandwiched between two lenses may include the optical-axis-direction positioning portion and the radial positioning portion on both end surfaces in the optical axis direction, respectively.

Although a case where the lens is a meniscus lens has been described as an example in the descriptions of the above respective embodiments and modification example, a lens to be fitted into the lens unit may be a biconvex lens or a biconcave lens. Additionally, the lens may not be limited to a single lens but may be a cemented lens.

Additionally, although a case where the lens outer edge is constituted by the end surfaces of the flange portion at both ends in the optical axis direction has been described as an example in the descriptions of the above respective embodiments and modification example, the lens outer edge may be constituted by a lens surface outside an optical effective region.

Additionally, although a case where the lens is formed by molding has been described as an example in the descriptions of the above respective embodiments and modification example, even when the lens is formed by cutting or polishing, the radial positioning portion is formed on the positioning projection inside the lens side surface compared to a case where radial positioning is performed by the lens side surface. Accordingly, since high-precision processing region can be reduced, manufacturing can be easily performed at low costs.

Additionally, the constituent elements described in the above respective embodiments and modification example may be embodied by appropriate combinations or deletion in the scope of the technical idea of the present invention.

For example, the constituent elements may be embodied by combining the above first and second embodiments. That is, as an example, when the lens unit 1 is constituted by three lenses, it is possible to adopt a configuration in which a lens having the same configuration as the second lens 33 is used as the third lens, the reference cylindrical surface 33j_{R} is internally fitted to the radial positioning surface 4i_{R}, and the abutting surface 33k_{A} is made to abut the tip surface 3k_{A} of the second lens 3 in the optical axis direction.

Although the preferred examples of the present invention have been described above, the present invention is not limited to these examples. Additions, omissions, substitutions, and other modifications can be made without departing from the spirit of the present invention. The present invention is not to be considered as being limited by the foregoing description, and is limited only by the scope of the appended claims.

1. A lens comprising
a lens side surface which has a lens surface portion and a plurality of lens outer edges formed on an outer peripheral side of the lens surface portion on end surfaces of both ends in a direction along an optical axis, the lens side surface being adjacent to the lens outer edge and serves as an outermost surface in a direction orthogonal to the optical axis,
wherein the lens is mountable on a lens holding frame that covers the lens side surface from the outer peripheral side,
wherein an optical-axis-direction positioning portion is provided within one plane orthogonal to the optical axis and on at least one of the lens outer edges formed at the end surfaces of both the ends, respectively, and
wherein a positioning projection is formed on at least one of the lens outer edges so as to protrude in the direction along the optical axis from a position closer to an inner peripheral side than the lens side surface, and the positioning projection has a radial positioning portion provided in a fixed positional relationship with the optical axis in the direction orthogonal to the optical axis.

2. The lens according to claim 1,
wherein the positioning projection includes the optical-axis-direction positioning portion.

3. A lens unit comprising:
the lens according to claim 1; and
a lens holding frame which includes a lens fitting portion that fits the radial positioning portion of the lens, an optical-axis-direction reference surface that allows the optical-axis-direction positioning portion of the lens to abut thereagainst, and a lens accommodation hole having a hole with a larger outer shape than the outer shape of the lens side surface of the lens,
wherein the lens is positioned by being fitted to the lens fitting portion and abutted against the optical-axis-direction reference surface.

4. The lens unit according to claim 3, comprising a plurality of the lenses,
wherein the optical-axis-direction reference surface abuts against the optical-axis-direction positioning portion of one of the plurality of lenses,
wherein the plurality of lenses are fitted to a plurality of the lens fitting portions, respectively, and
wherein the lenses that are arranged adjacent to each other are positioned in the direction along the optical axis by abutting the optical-axis-direction positioning portions that are provided on the end surfaces that face each other.

5. A lens manufacturing method comprising:
a step of forming a molding tool assembly; and
a step of molding a molding material using the molding tool assembly to form the outer shape of the lens according to claim 1,
wherein the molding tool assembly includes,
a first molding tool member that transfers the shape of at least a portion of the lens outer edge and the shape of the lens surface portion in one of the end surfaces of both the ends;
a second molding tool member that transfers the shape of at least a portion of the lens outer edge and the shape of the lens surface portion in the other of the end surfaces; and
a third molding tool member that transfers the shape of at least the lens side surface, and
wherein a radial positioning portion molding surface that transfers the shape of the radial positioning portion is formed so as to be provided on at least one of the first molding tool member and the second molding tool member.

6. The lens manufacturing method according to claim 5,
wherein a molding surface for molding the lens surface portion of the end surface where the radial positioning portion is further provided in the first molding tool member or the second molding tool member where the radial positioning portion molding surface is provided.
